(19) United States
(12) Patent Application Publication
(10) Pub. No.: US 2014/0192072 A1
(43) Pub. Date: Jul. 10, 2014

(54) DRAWING CONTROL DEVICE

(71) Applicant: Hiroyasu Negishi, Tokyo (JP)

(72) Inventor: Hiroyasu Negishi, Tokyo (JP)

(73) Assignee: Mitsubishi Electric Corporation, Tokyo (JP)

(21) Appl. No.: 14/239,628

(22) PCT Filed: Jan. 6, 2012
(86) PCT No.: PCT/JP2012/000058

§ 371 Date: Feb. 19, 2014

(51) Int. Cl. G06T 11/20

(52) U.S. Cl. CPC G06T 11/20
USPC 345/522

(57) ABSTRACT

An arithmetic processor 1 includes a queuer 102 that controls a queue memory 102, a load database 103 that holds drawing load information corresponding to a search key which can be extracted from a drawing command, a load determinator 104 that searches through the load database 103 for drawing load information according to the drawing command stored in the queue memory, and that calculates a drawing processing time of the above-mentioned drawing command, and a drawing scheduler 105 that instructs the queuer 102 to change an order in which the drawing command stored in the queue memory 21 is processed and/or to divide the above-mentioned drawing command on the basis of a priority assigned to the above-mentioned drawing command and the drawing processing time of the above-mentioned drawing command calculated by the load determinator 104.

### FIELD OF THE INVENTION

The present invention relates to a drawing control device having a function of, when performing a drawing process of drawing a graphic, characters, etc., carrying out the drawing according to the priorities assigned to a plurality of applications, and making a plurality of applications operate smoothly while keeping them in good balance.

### BACKGROUND OF THE INVENTION

Conventionally, when performing a drawing process of drawing a graphic, characters, etc., a drawing process with a priority and a drawing interrupt process are carried out (for example, refer to patent references 1 to 3). For example, when making a transition from a low-priority process to a high-priority process, after hardware that is performing the low-priority process is stopped temporarily and processed information in the hardware is saved, the high-priority process is performed. After the high-priority process is then completed, the information of the low-priority process is restored and this low-priority process is performed. Further, when performing a drawing process which complies with conventional drawing scheduling, the processing order of a drawing command is changed within a queue memory for storing drawing commands according to the priority assigned to the drawing command, or the drawing command is divided into parts according to the drawing processing time of the drawing command which is acquired by referring to an execution time table (for example, refer to patent reference 4).

### RELATED ART DOCUMENT

### Patent Reference

Patent reference 1: Japanese Unexamined Patent Application Publication No. Hei 7-271344
Patent reference 2: Japanese Unexamined Patent Application Publication No. Hei 11-133943
Patent reference 3: Japanese Unexamined Patent Application Publication No. 2007-241629
Patent reference 4: Japanese Unexamined Patent Application Publication No. 2010-182139

### SUMMARY OF THE INVENTION

### Problems to be Solved by the Invention

As mentioned above, conventional devices that carry out a graphics operation, which are disclosed by patent references 1 to 3, use a method of temporarily stopping hardware and saving the internal information. Therefore, the hardware for graphics drawing needs to be able to deal with interrupt processing and save and restore the operation state information about the hardware, and to restart the drawing process from halfway through. However, current graphics processing has many states including 3D graphics states and vector graphics states, and also has many states in hardware. Further, taking into consideration the fact that the processing pipeline has a large depth, and the possibility that the interrupt processes are accepted in a state in which the hardware can re-operate and the time required to save the operation state information using software, there are very few execution environments in which hardware can implement these processes.

When there are no hardware execution environments as mentioned above, interrupt cannot be accepted during the drawing process, and the next process will be performed only after the completion of the process currently being performed. A problem is therefore that when the occupation time of the drawing hardware is long, such as when a large volume of three-dimensional drawing, map drawing, or the like is carried out, the occurrence of a high-priority request to urgently produce a display cannot be handled. For example, in the case of producing a display on the instrument panel of a car, the drawing of an instrument, such as a speedometer, must be updated 30 or 60 times per second, while such a severe ability as that required of the speedometer is not required of the drawing of a map for use in car navigation or the like. That is, a higher priority is assigned to the drawing of the speedometer while a lower priority is assigned to the drawing for navigation. In this case, when the use of a conventional method causes drawing of a large volume of data in order to improve the map drawing performance, the H/W may be occupied and it may become impossible to keep the frequency of updating the drawing of the speedometer.

Further, a conventional device that carries out scheduling, which is disclosed by patent reference 4, acquires the drawing processing time of each drawing command from an execution time table, and, when this drawing processing time is equal to or greater than a predetermined time, divides the drawing command into parts. A problem is, however, that the execution time table simply holds the drawing processing time of each drawing command itself, and the device cannot acquire the drawing processing time from a plurality of items for determining the drawing processing time (drawing conditions including a drawing area and the number of vertices). A further problem with the device disclosed by patent reference 4 is that a single CPU is assumed as an arithmetic processor that carries out scheduling on drawing commands, and therefore the device cannot handle applications other than only applications that operate on the single CPU. Therefore, the device can carry out neither scheduling on applications between processor cores in the case of using an arithmetic processor having a multi core structure nor scheduling on applications between arithmetic processors in the case of having a multi CPU structure.

The present invention is made in order to solve the above-mentioned problems, and it is therefore an object of the present invention to provide a drawing control device that can take into consideration coping with a high-priority process even in an environment where hardware cannot cope with interrupts and so on, and that can cause a plurality of applications to operate smoothly while keeping them in good balance.

### Means for Solving the Problem

In accordance with the present invention, there is provided a drawing control device including an arithmetic processor having a drawing program that issues a drawing command to which a priority is assigned, and a queue memory that stores the drawing command issued by the drawing program, the arithmetic processor including: a queuer that controls the queue memory; a load database that holds drawing load information corresponding to a search key which can be extracted from a drawing command; a load determinator that searches through the load database for drawing load information according to the drawing command stored in the queue memory, and that calculates a drawing processing time of the above-mentioned drawing command; and a drawing scheduler that instructs the queuer to change an order in which the above-mentioned drawing command stored in the queue memory is processed and/or to divide the above-mentioned drawing command on the basis of the priority assigned to the drawing command and the drawing processing time of the drawing command calculated by the load determinator.

### Advantages of the Invention

Because the drawing control device in accordance with the present invention is constructed as above, the drawing control device can take into consideration coping with a high-priority process even in an environment where hardware cannot cope with interrupts and so on, and can cause a plurality of applications to operate smoothly while keeping them in good balance.

### BRIEF DESCRIPTION OF THE FIGURES

FIG. 1 is a diagram showing the structure of a drawing control device in accordance with Embodiment 1 of the present invention;

FIG. 2 is a flow chart showing the operation of the drawing control device in accordance with Embodiment 1 of the present invention;

FIG. 3 is a diagram explaining the operation of the drawing control device in accordance with Embodiment 1 of the present invention;

FIG. 4 is a diagram showing the structure of a drawing control device in accordance with Embodiment 2 of the present invention;

FIG. 5 is a diagram showing the structure of a drawing control device in accordance with Embodiment 3 of the present invention; and

FIG. 6 is a diagram showing the structure of a drawing control device in accordance with Embodiment 4 of the present invention.

### EMBODIMENTS OF THE INVENTION

Hereafter, the preferred embodiments of the present invention will be explained in detail with reference to the drawings.

### Embodiment 1

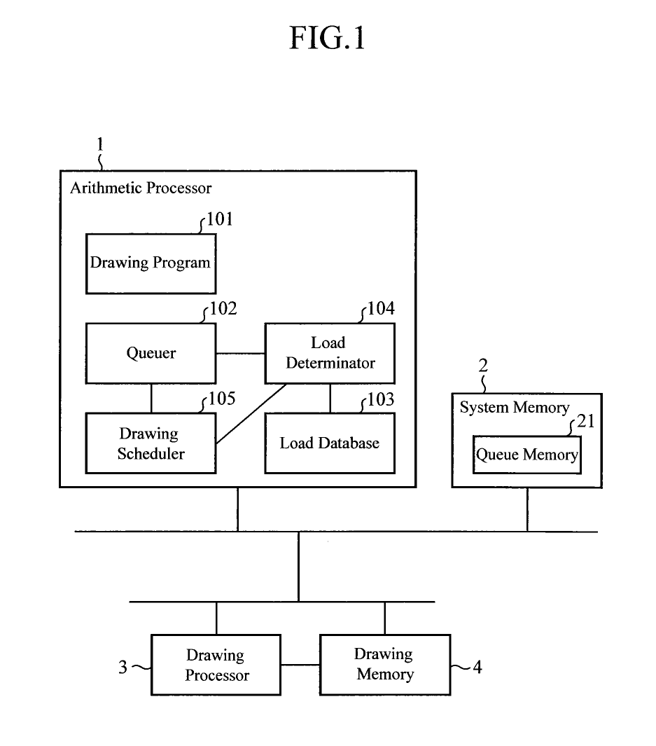

FIG. 1 is a diagram showing the structure of a drawing control device in accordance with Embodiment 1 of the present invention. The drawing control device is comprised of an arithmetic processor 1, a system memory 2, a drawing processor 3, and a drawing memory 4, as shown in FIG. 1.

The arithmetic processor 1 executes a plurality of applications and a plurality of tasks on an operating system (OS), and issues drawing requests, such as a character and graphic drawing request and a drawing control request, to the drawing processor 3. The arithmetic processor 1 consists of, for example, a CPU. This arithmetic processor 1 is comprised of a drawing program 101, a queuer 102, a load database 103, a load determinator 104, and a drawing scheduler 105.

The drawing program 101 calls a predetermined drawing API (Application Program Interface) and issues a drawing command to form a drawing request by using this drawing API. A priority is assigned to this drawing command. The drawing command issued by this drawing program 101 is stored in a queue memory 21, which will be mentioned below, in the system memory 2

The queuer 102 controls the queue memory 21 according to an instruction provided by the drawing scheduler 105. The load database 103 holds drawing load information corresponding to a search key (a drawing condition) which can be extracted from a drawing command.

The load determinator 104 searches through the load database 103 for drawing load information according to a drawing command stored in the queue memory 21, and calculates the drawing processing time of this drawing command. More specifically, the load determinator 104 analyzes a drawing command stored in the queue memory 21 via the queuer 102 to extract a search key first. The load determinator then searches through the load database 103 for corresponding drawing load information by using the extracted search key, and calculates the drawing processing time. The drawing processing time of the drawing command calculated by this load determinator 104 is notified to the drawing scheduler 105.

The drawing scheduler 105 instructs the queuer 102 to change the processing order in which a drawing command stored in the queue memory 21 is processed and/or to divide the drawing command on the basis of both the priority assigned to the drawing command and the drawing processing time of the drawing command calculated by the load determinator 104. The drawing scheduler 105 also issues a drawing instruction to the drawing processor 3.

The system memory 2 holds instruction codes and data of the arithmetic processor 1. This system memory 2 has the queue memory 21. The queue memory 21 stores a drawing command from the drawing program 101.

According to the drawing instruction from the drawing scheduler 105, the drawing processor 3 carries out drawing processes (a two-dimensional drawing process including straight line drawing and area transfer, a three-dimensional graphics process, a vector graphics process, etc.) according to a drawing command stored in the queue memory 21. This drawing processor 3 is comprised of, for example, a graphics accelerator, a graphics engine, or a GPU (Graphics Processing Unit). The drawing processor 3 uses the drawing memory 4 when carrying out drawing.

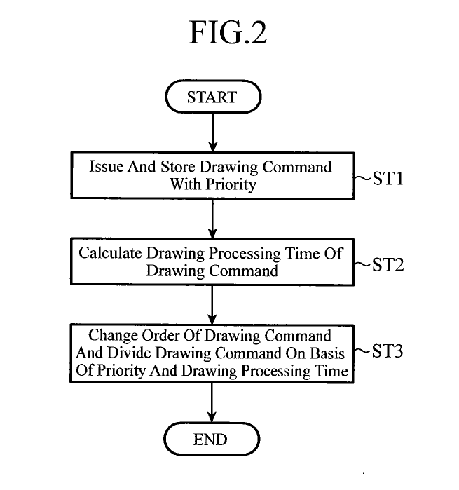

Next, the operation of the drawing control device constructed as above will be explained with reference to FIG. 2. In the drawing control device, the drawing program 101 issues a predetermined drawing command to which a priority is assigned and stores the drawing command in the queue memory 21 first (step ST1), as shown in FIG. 2.

Then, the load determinator 104 searches through the load database 103 for corresponding drawing load information according to the drawing command stored in the queue memory 21, and calculates the drawing processing time of the drawing command (step ST2). More specifically, the load determinator 104 analyzes the drawing command stored in the queue memory 21 via the queuer 102 first to extract a search key. The search key includes an area (drawing area) on the screen in which drawing is to be performed according to the drawing command, and the number of vertices included in the drawing command. Further, each drawing load information held by the load database 103 includes a filling process time governed by a drawing area and a coordinate transformation time governed by the number of vertices. The load determinator 104 then searches through the load database 103 for corresponding drawing load information (a filling process time and a coordinate transformation time) by using the extracted search key, and calculates the drawing processing time of the drawing command.

The drawing scheduler 105 then changes the processing order in which the drawing command stored in the queue memory 21 is processed and/or divides the drawing command on the basis of both the priority assigned to the drawing command and the drawing processing time of the drawing command calculated by the load determinator 104 by way of the queuer 102 (step ST3). By changing the processing order of this drawing command, the drawing control device can carry out processes having a higher priority on a priority basis. Further, by dividing the drawing command, the drawing scheduler can prevent a series of drawing commands from taking up the drawing processor 3 for a long time.

When changing the processing order of the drawing command by this drawing scheduler 105, the drawing command whose processing order to be changed is inserted behind any other drawing command whose priority is higher than that of the drawing command. When the drawing area of the drawing command whose processing order to be changed overlaps the drawing area of another drawing command, the drawing command is inserted behind the other drawing command whose drawing area overlaps that of the drawing command.

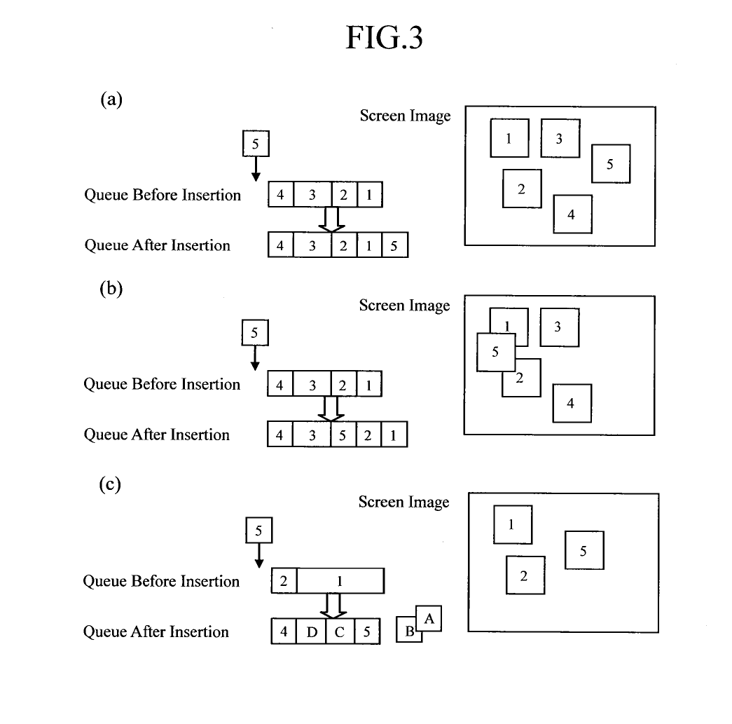

For example, when the drawing area of the drawing command 5 having a high priority does not overlap that of any other drawing command stored in the queue before insertion, as shown in FIG. 3(a), the drawing command 5 is inserted behind any other drawing command whose priority is higher than the drawing command 5. In the example of FIG. 3(a), a case in which there exists no drawing command whose priority is higher than the drawing command 5 and the drawing command 5 is inserted at the head in the queue memory 21 is shown. In contrast, when the drawing area of the drawing command 5 having a high priority overlaps those of drawing commands 1 and 2 stored in the queue before insertion, as shown on a right side of FIG. 3(b), the drawing command 5 is inserted behind the drawing command 2, as shown on a left side of the figure. As a result, a correct screen image can be maintained.

Further, when a drawing command 1 to draw a large amount of data (the drawing command takes much drawing processing time) is stored in the queue before insertion, as shown in FIG. 3(c), the drawing command 1 is divided into drawing commands A to D. As a result, the drawing command 5 can be inserted within the drawing command 1, it becomes unnecessary for the drawing control device to wait for the process according to the drawing command 5 until the process according to all of the drawing command 1 is completed. In the example of FIG. 3(c), a case in which the drawing command 5 issued during the process according to the drawing command 1 (after the drawing processes according to the drawing commands A and B after division are completed) is inserted before the drawing command C which is placed at the head of the queue memory 21 at that time is shown. As a result, the drawing control device can implement the drawing operations of a plurality of applications with stability while preventing a specific application from taking up the drawing H/W.

In this embodiment, the drawing control device can have a server client type structure in which the drawing program 101 is provided as a client and the drawing scheduler 105 is provided as a server, and can use a method of exchanging data between the client and the server. Further, although the drawing processor 3 draws data in the drawing memory 4 in this embodiment, the drawing memory 4 can be eliminated from the system and the drawing processor 3 can alternatively draw data in the system memory 2.

In addition, the load database 103 enables drawing load information to be searched for on the basis of the drawing area and the number of vertices which are extracted from a drawing command. As a result, the drawing control device can carefully deal with, for example, a condition that the drawing area is very small, but the number of vertices is large, a condition that the number of vertices is small, but the drawing area is large, and so on. Further, although the drawing area and the number of vertices are used as the search key in the above-mentioned example, drawing quality can be added to these quantities. As a parameter showing the drawing quality, for example, a setting showing whether or not to enable antialiasing for removing aliasing at edges, a pixel resolution for the antialiasing process, the number of samplings, or a filtering method at the time of enlargement or reduction can be provided. By taking this drawing quality into consideration, the filling process time can be classified finely. Further, because in a translucentizing process, fog, or the like, reading and writing of a memory occurs on a per pixel basis, and the filling process time differs from a typical one, the filling process time can be included as a search key. By setting the search key finely this way, the drawing control device can improve the accuracy of the drawing processing time and implement the division of the drawing command optimally, thereby being able to implement the drawing operations of a plurality of applications with stability.

As mentioned above, because the drawing control device in accordance with this Embodiment 1 is constructed in such a way as to change the processing order in which a drawing command in the queue memory 21 is processed and divide the drawing command in the queue memory 21 on the basis of the priority assigned to the drawing command and the drawing processing time which is acquired from a search key extracted from the drawing command, the drawing control device can take into consideration coping with a high-priority process even in an environment where hardware cannot cope with interrupts and so on, and can cause a plurality of applications to operate smoothly while keeping them in good balance.

### Embodiment 2

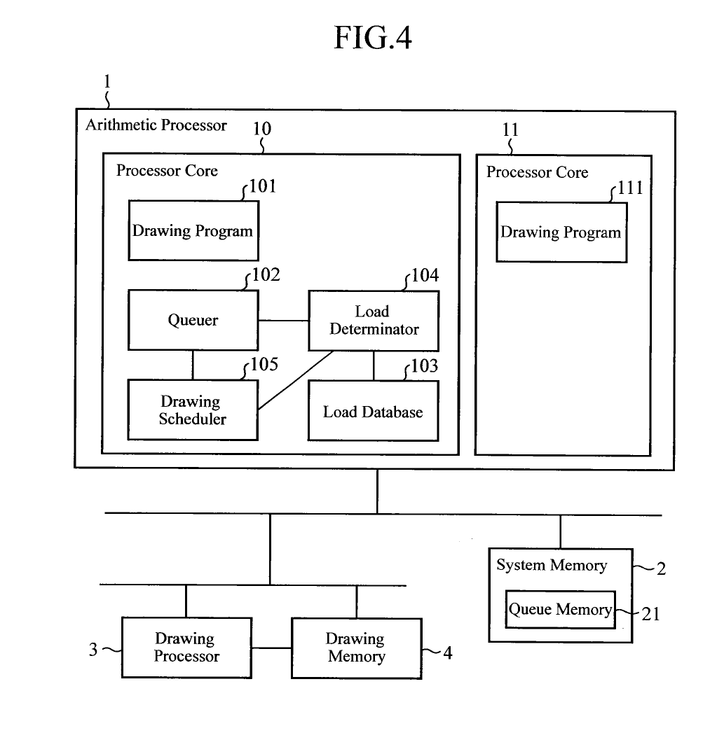

FIG. 4 is a diagram showing the structure of a drawing control device in accordance with Embodiment 2 of the present invention. In the drawing control device in accordance with Embodiment 2 shown in FIG. 4, a plurality of processor cores 10 and 11 are disposed in the arithmetic processor 1 of the drawing control device in accordance with Embodiment 1 shown in FIG. 1. In FIG. 4, the example shown in Embodiment 1 is equivalent to a case in which the components operate independently in the processor core 10. More specifically, each functional unit in the processor core 10 shown in FIG. 4 has the same structure as each functional unit in the arithmetic processor 1 shown in FIG. 1.

A drawing program 111 is disposed in the processor core 11. This drawing program 111 carries out the same processing as that carried out by a drawing program 101 in the processor core 10. Then, when a single drawing processor 3 is used by the two processor cores 10 and 11, the processor core 11 can implement drawing with priority and drawing stabilization between applications by applying the structure in accordance with Embodiment 1 operating in the processor core 10.

For example, this embodiment corresponds to a case in which when producing an instrument panel display for a car, an application used for instruments or the like that needs to perform an update of drawing 30 or 60 times per second and an application used for car navigation or the like that needs to perform an update of drawing about 30 or 15 times per second are made to separately operate in the processor core 10 and the processor core 11.

In this case, the drawing program 101 that causes an application having a high priority used for instruments or the like to operate and the drawing program 111 that causes an application having a low priority used for car navigation or the like to operate store their respective drawing commands in a queue memory 21. Then, a load determinator 104 extracts a search key from each of the drawing commands stored in the queue memory 21, searches through a load database 103 for drawing load information, and calculates the drawing processing time of each of the drawing commands. When the drawing processing time of the drawing command having a lower priority exceeds a switch time for switching between drawing processes, a drawing scheduler 105 then divides the drawing command by way of a queuer 102. The drawing scheduler then raises the priority of the drawing command having a higher priority by moving the drawing command to a most forward position, in the queue memory 21, where the drawing command can be inserted. By dividing the drawing command which takes much drawing processing time this way, the drawing control device can push the process having a higher priority in front of other processes having lower priorities.

Further, even when different OSs run on the processor cores 10 and 11, the queue memory 21 can be shared by sharing the system memory 2, and the processing order of a drawing command can be changed and a division of a drawing command can be carried out. By causing OSs to separately run in the processor cores 10 and 11, an important display, such as a display of a speedometer, can be managed on an OS different from other drawing programs. As a result, there is a merit of, even when a program crashes, resetting this program at a high speed by simply restarting the OS of this processor core.

As mentioned above, because the drawing control device having a multi core structure in accordance with this Embodiment 2 is constructed in such a way as to change the processing order in which a drawing command in the queue memory 21 is processed and divide the drawing command in the queue memory 21 on the basis of the priority assigned to the drawing command and the drawing processing time which is acquired from a search key extracted from the drawing command, the drawing control device can take into consideration coping with a high-priority process even in an environment where hardware cannot cope with interrupts and so on, and can cause a plurality of applications to operate smoothly while keeping them in good balance.

### Embodiment 3

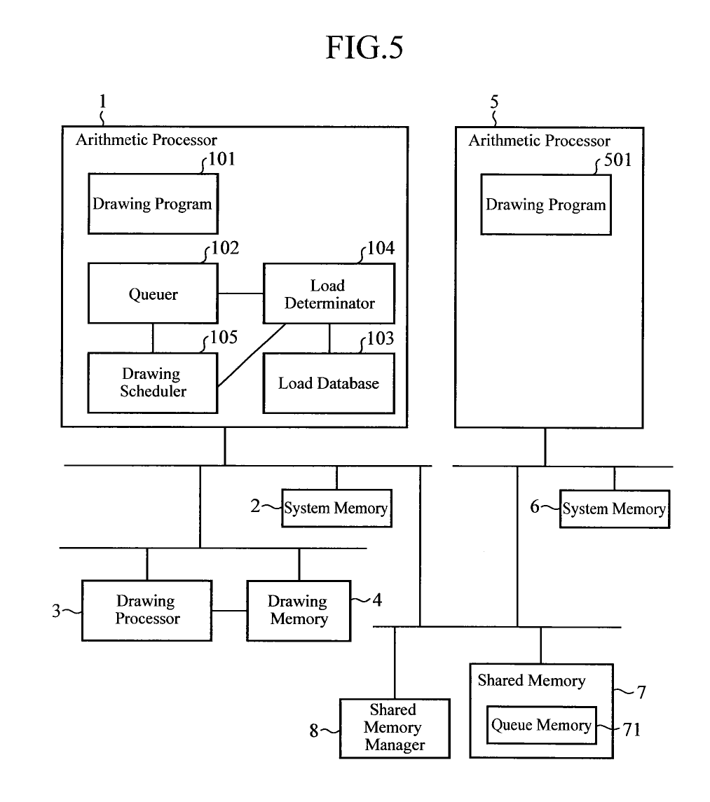

In Embodiment 3, a case in which in a drawing control device having a multi CPU structure in which a processor (high-class processor) with a drawing processor and a processor (small processor) without a drawing processor coexist, the small processor uses the drawing processor which the high-class processor has is shown. FIG. 5 is a diagram showing the structure of the drawing control device in accordance with Embodiment 3 of the present invention. The drawing control device in accordance with Embodiment 3 shown in FIG. 5 is the one in which the queue memory 21 is removed from the drawing control device in accordance with Embodiment 1 shown in FIG. 1, and a small processor (an arithmetic processor 5 and a system memory 6), a shared memory 7, and a shared memory manager 8 are added. The other structural components of the drawing control device are the same and are designated by the same reference numerals, and the explanation of the other structural components will be omitted hereafter.

The arithmetic processor 5 includes a drawing program 501. This drawing program 501 carries out the same processing as that carried out by a drawing program 101 of an arithmetic processor 1. Further, the system memory 6 carries out the same processing as that carried out by a system memory 2.

The shared memory 7 is shared by the arithmetic processor 1 and the arithmetic processor 5, and has a queue memory 71. The queue memory 71 stores drawing commands issued respectively by the drawing programs 101 and 501 of the arithmetic processors 1 and 5. The shared memory manager 8 controls the shared memory 7 between the arithmetic processors 1 and 5. As a result, drawing with priority and drawing stabilization between applications can be implemented between the drawing command issued by the arithmetic processor 1 and the drawing command issued by the arithmetic processor 5.

More specifically, the drawing programs 101 and 501 operating respectively in the arithmetic processors 1 and 5 temporarily store the drawing commands issued thereby in the queue memory 71 of the shared memory 7. Then, a load determinator 104 of the arithmetic processor 1 having the drawing processor 3 extracts a search key from each of the drawing commands stored in the queue memory 71 by way of a queuer 102, searches through a load database 103 for drawing load information, and calculates the drawing processing time of each of the drawing commands. Then, a drawing scheduler 105 changes the processing order in which each of the drawing commands stored in the queue memory 71 is processed and divide each of the drawing commands by way of the queuer 102 on the basis of the priority assigned to each of the drawing commands and the drawing processing time of each of the drawing commands which is calculated by the load determinator 104, thereby implementing drawing with priority and stabilization between applications.

As mentioned above, because the drawing control device having a multi CPU structure in accordance with this Embodiment 3 is constructed in such a way as to change the processing order in which a drawing command in the queue memory 71 is processed and divide the drawing command in the queue memory 71 on the basis of the priority assigned to the drawing command and the drawing processing time which is acquired from a search key extracted from the drawing command, the drawing control device can take into consideration coping with a high-priority process even in an environment where hardware cannot cope with interrupts and so on, and can cause a plurality of applications to operate smoothly while keeping them in good balance.

### Embodiment 4

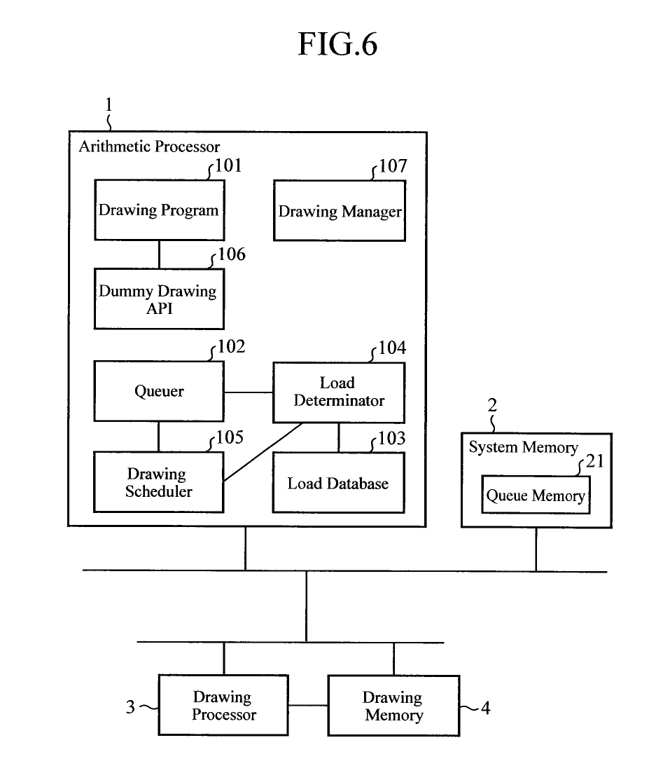

FIG. 6 is a diagram showing the structure of a drawing control device in accordance with Embodiment 1 of the present invention. The drawing control device in accordance with Embodiment 4 shown in FIG. 6 additionally includes a dummy drawing API (API processor) 106 and a drawing manager 107 in addition to the components of the drawing control device in accordance with Embodiment 1 shown in FIG. 1. The other structural components of the drawing control device are the same and are designated by the same reference numerals, and the explanation of the other structural components will be omitted hereafter.

The dummy drawing API 106 reads a standard API called by a drawing program 101 under the control of the drawing manager 107, issues a drawing command to which a priority is assigned by using the standard API, and stores the drawing command in a queue memory 21. The drawing manager 107 controls the dummy drawing API 106.

Because when a drawing API which the drawing program 101 uses is a standard API, such as OpenGL, no drawing command can be stored in the queue memory 21 because writing into the queue memory 21 is not assumed in this standard API. Therefore, this standard API is written temporarily into the dummy drawing API 106, and a drawing command to which a priority is assigned is issued by using the dummy drawing API 106 and is stored in the queue memory 21. As a result, even in the case in which a standard API is used, the processing order in which the drawing command is processed can be changed and the drawing command can be divided.

In this embodiment, the drawing control device can have a server client type structure in which the dummy drawing API 106 is provided as a client and a drawing scheduler 105 is provided as a server, and can use a method of exchanging data between the client and the server.

As mentioned above, because the drawing control device in accordance with this Embodiment 4 is constructed in such a way that a standard API called by the drawing program 101 is written in the dummy drawing API 106, and a drawing command is issued by using the dummy drawing API 106 and is stored in the queue memory 21, the drawing control device can provide the same advantage as that provided by Embodiment 1 even in the case in which the drawing program 101 uses a standard API.

While the invention has been described in its preferred embodiments, it is to be understood that an arbitrary combination of two or more of the above-mentioned embodiments can be made, various changes can be made in an arbitrary component in accordance with any one of the above-mentioned embodiments, and an arbitrary component in accordance with any one of the above-mentioned embodiments can be omitted within the scope of the invention.

### INDUSTRIAL APPLICABILITY

Because the drawing control device in accordance with the present invention is constructed as above, the drawing control device can take into consideration coping with a high-priority process even in an environment where hardware cannot cope with interrupts and so on, and can cause a plurality of applications to operate smoothly while keeping them in good balance, and is suitable for use as a drawing control device that draws a graphic, characters, etc., and so on.

### EXPLANATIONS OF REFERENCE NUMERALS

1 and 5 arithmetic processor, 2 and 6 system memory, 3 drawing processor, 4 drawing memory, 7 shared memory, 8 shared memory manager, 10 and 11 processor core, 21 and 71 queue memory, 101 drawing program, 102 queuer, 103 load database, 104 load determinator, 105 drawing scheduler, 106 dummy drawing API (API processor), 107 drawing manager, 111 drawing program, 501 drawing program.

1. A drawing control device including an arithmetic processor having a drawing program that issues a drawing command to which a priority is assigned, and a queue memory that stores the drawing command issued by said drawing program, said arithmetic processor comprising:
a queuer that controls said queue memory;
a load database that holds drawing load information corresponding to a search key which can be extracted from a drawing command;
a load determinator that searches through said load database for drawing load information according to the drawing command stored in said queue memory, and that calculates a drawing processing time of said drawing command; and
a drawing scheduler that instructs said queuer to change an order in which the drawing command stored in said queue memory is processed and/or to divide said drawing command on a basis of the priority assigned to said drawing command and the drawing processing time of said drawing command calculated by said load determinator.

2. The drawing control device according to claim 1, wherein said arithmetic processor has a multi core structure, and includes a first processor core having said drawing program, said queuer, said load database, said load determinator, and said drawing scheduler, and a second processor core having said drawing program.

3. The drawing control device according to claim 2, wherein different OSs run on said processor cores respectively.

4. The drawing control device according to claim 1, wherein said drawing control device includes a second arithmetic processor having said drawing program, and, instead of said queue memory, a shared memory that stores a drawing command issued by the drawing program of each of said arithmetic processors, and wherein said load determinator searches through said load database for drawing load information according to the drawing command stored in said shared memory, and calculates the drawing processing time of said drawing command, and said drawing scheduler instructs said queuer to change the order in which the drawing command stored in said shared memory is processed and/or to divide said drawing command on a basis of the priority assigned to said drawing command and the drawing processing time of said drawing command calculated by said load determinator.

5. The drawing control device according to claim 1, wherein a drawing area and a number of vertices are included in said search key.

6. The drawing control device according to claim 5, wherein drawing quality is included in said search key.

7. The drawing control device according to claim 1, wherein said drawing program calls a standard API, and said drawing control device includes an API processor that reads the standard API which is called, instead of issuing the drawing command by said drawing program, and that issues a drawing command to which a priority is assigned by using said standard and stores the drawing command in said queue memory.
